(19) United States
(12) Patent Application Publication
(10) Pub. No.: US 2019/0100858 A1
(43) Pub. Date: Apr. 4, 2019

(54) Carbonization reactor for the combined production of construction materials and electricity by means of sunlight

(71) Applicant: Kolja Kuse, Munchen (DE)

(72) Inventor: Kolja Kuse, Munchen (DE)

(21) Appl. No.: 15/544,209

(22) PCT Filed: Jan. 18, 2016
(86) PCT No.: PCT/EP2016/000079

§ 371 Date: Apr. 19, 2018

(30) Foreign Application Priority Data
Jan. 17, 2015 (DE) 2020150000375.3

(51) Int. Cl. D01F 9/32; D01F 9/22; F24S 23/00

(52) U.S. Cl. CPC D01F 9/328; F24S 23/12; D01F 9/22

(57) ABSTRACT

The invention describes an energy-efficient method for simultaneous generation of carbon fibers and electricity by means of bundled sunlight for the CO2-neutral production of pressure- and tensile-stable building materials, which are able to bind anthropogenic carbon, in case the carbon fibers are produced from vegetable oils. Through the oil generation by photosynthesis, carbon dioxide is being split off and carbon is being bound in the oil, as well as oxygen is being released.

Due to the fact that the production energy has a purely regenerative character, it is ensured that in the short-term not only carbon neutrality can not be introduced, but carbon is permanently withdrawn from the climate system of atmosphere and ocean.

The energy efficiency is based on the principle to heat the carbon fiber to be produced directly up with bundled sunlight, which is made possible by the fact that the original PAN fiber becomes dark during the oxidation and pyrolysis process and finally becomes an almost ideal black body.

The resulting heat is used subsequently or simultaneously to the material production of the fiber for the production of electricity, which corresponds to the classical combined heat and power principle, in order to additionally increase the efficiency in carbon fiber production already increased by this process, by delivery of energy in form of high valuable electricity.

The fibers are used on demand in combination with mineral material as a substitute for CO2—intensive construction materials such as steel concrete, steel and aluminum.

After use the carbon fibers are separated from the stone by peeling and stored away without large energy expenditure in underground or above-ground camps without difficulty, whereby the carbon bound in the carbon fiber remains permanently bound.

Thus, the economy is becoming the driving force behind advancing decarbonization with a negative algebraic sign.

The present invention describes an arrangement for the simultaneous generation of carbon based building material and electricity by means of sunlight. The method is based on the fundamental idea of the European patent application with the application number 09796616.2, which describes how pressure and tension stable building materials based on carbon and hard rock can be obtained from CO2 from atmosphere or ocean . carbon-carbon and hard rock (example EP 106 20 92), wherein the carbon fiber is obtained from algae oil and the required production energy from bundled sunlight. The present invention describes how this can be taken into reality in a technically and financially viable way.

A modern civilisation and the therefore necessary industrial production of facilities and consumer good of a modern life style with its buildings, mobility and working machines without the availability of pressure and tensile stable materials, as they are provided by steel-concrete, Steel, glass and aluminium are not conceivable today. However, the production of these materials, which are artificially created by human beings, requires a large quantity of energy for their production, which can only be obtained at a sufficient rate by the fact that 70 to 80% fossil fuels are produced for the required energy supply.

As a result, large and ever larger quantities of CO2 are still released, although the proportion of renewable energy is increasing because the global economy is steadily growing. The fact that the production processes for cement, steel and aluminum are process-related with CO2 emissions is also not well-known, which could not be avoided by other methods: when limestone is being burned for the cement production, CO2 is being released as a result, in the production of steel, CO2 is produced by the admixture of coke into the steel melt, and also by the immersion of the graphite electrodes into the aluminum melt, CO2 is being produced. This share of CO2 emissions remains by the manufacture of these materials, even if the required production energy would come from 100% renewable energy sources.

Against the backdrop of the by now unquestioned climate warming and the necessity of limit the associated temperature increase of the atmosphere by anthropogenic greenhouse gases to an increase by less than 2K, ideally as at the COP21 in Paris 2015 decided to a limit of 1.5K compared to the preindustrial time and, If possible, to bring temperatures back to pre-industrial values as quickly as possible, it becomes important to remove and store carbon permanently as long as possible, in addition to reducing emissions of greenhouse gases through regenerative energy (mitigation).

In this sense, we meanwhile speak of a decarbonization, but in the sense of negative emissions, which can eventually compensate for the positive emissions which may occur, but which can, in particular, serve long-term return of all the emissions backinto the earth, which have been released during the industrial ages.

This kind of storage should be performed in an uncomplicated way, safe, riskless and with little energy expenditure. It would also be desirable if the stored carbon is easily accessible and can be partially re-used as required. Since the return of carbon into a solid aggregate state is energetically complex, this production has to be carried out as energy-efficient as possible and should be ideally linked to other processes and serve in parallel or simultaneously other purposes beside the production of carbon-bonding processes, for example the simultaneous material production and power generation by power-heat cogeneration.

Since the effort to return carbon to where it came from can be realized by the existing world economy in reasonable time with currently available technology at realistic costs can only over a thousand years, and in doing so due to the bound oxygen a lot of space or high gas compression is needed, new mechanisms must be developed to achieve this return of carbon dioxide emissions of anthropogenic origin in solid form and without the oxygen component into ground within a reasonable period of 300 to 400 years at the latest, which corresponds approximately to the period which Johann Wolfgang von Goethe had undertaken for the reafforestation of the German forest, The latter was almost completely cut down in its time, because wood was not only used for heating, but also for metal production.

The use of coal made the necessary relief here, in order to preserve the forests and to replant them, which in turn turned into the cause of the climate change. The fact that the industrialization caused long-term damage is thus not new and its long-term elimination not as well, as the efforts of Goethe and its contemporaries impressively showed by a now intact German forest.

The future decarbonisation with a simultaneous negative emission within tolerable periods of time is intended to become reality with this invention, in order to achieve at first a CO2 neutrality and in due course to reduce make CO2 emissions to become negative and thus resore already released emissions.

To achieve this goal, energy generation must be of renewable nature, energy efficiency must be increased, and CO2 emissions free materials production needs to be introduced, has being proposed by 09796616.2, and at the same time carbon should be, ideally and if possible, bound within the building material itself.

While 09796616.2 describes the basic procedural approach to achieve this goal from a holistic viewpoint, the present invention addresses the task of increasing the energy efficiency in a concrete and practical manner by the necessary factors. The production of materials in the manner described by 09796616.2 can thereby be “clean” when carbon fibers based on algae oil are being produced, rather than as before, on the basis of petroleum, and at the end of such a process chain carbon remains in a long-term bonded form. The amount of regenerative energy required for this can not be represented by existing solar and wind collector technologies, at least a factor of 2 of energy is missing for the production of suitable quantities of carbon fibers. At least this factor of 2 in energy efficiency can be generated with the present invention.

This is only possible when carbon itself is becoming used as a building material, and the required carbon fiber is being produced in a more energy-efficient manner with the help of sunlight than today with PV or CSP-plants is ever possible. Only in this case the desired conditions for a complete return of past carbon dioxide emissions is becoming established through the economy itself, as well as the control of future emissions.

The energy required for this can not be applied today because the use of solar energy by PV-Plants works with an efficiency of just under 18%, as well as solar thermal power plants with help of bundled sunlight work only with an efficiency of approx. 30%, the remaining captured solar energy vanishes in the form of heat, while the today yearly needed production energy for the significant quantities of carbon fibers being needed in order to replace the currently used building materials steel, reinforced concrete and aluminum would devour almost the entire global annual energy demand of currently 140,000 TWh in the form of electric power, taking today's energy efficiency into account.

As a result of the process proposed here, a large proportion of the heat energy lost in conventional solar thermal power plants is used primarily for the production of carbon fibers and the heat is subsequently used for the production of electricity, and the electricity is thus being generated as a “waste product”.

After the solar energy has been concentrated, the material production process is switched aheadbefore the electrical energy production takes place and the entire heat, including the heat lost during the generation of electricity, is being used for the carbonization process of the carbon fiber production. This increases the efficiency by a factor of 3. The invention relates to how this is technically implemented.

By the decarbonization methods of the atmosphere and the oceans, at the same time binding the carbon within the building material being produced out of carbon fibers, as being described in 09796616.2, more carbon dioxide is being withdrawn form biosphere by the entire process chain, including the mostly regenerative production of construction materials, than carbon dioxide is being produced by this material production. The provision of sufficient sea areas for algae production and additional land surfaces for the production of suitable vegetable oils is of central importance.

As a result of the above-mentioned argumentation, the consequent use of carbon fibers is proposed as a suitable building material and durable carbon slag since they can be used as a building material in an outstanding manner and at the same time bind carbon in this form in a climate-efficient manner, especially in case the necessary starting materials for the carbon fiber production are being produced out of algal oil. Starting materials are, for example, fibers of polyacrylonitrile (PAN fiber), which are being nowadays produced in a relatively simple process from petroleum and a spinning dissolution. This initial dissolution will in the future be produced with algae oil, which makes no difference technically. The dissolution is being pressed through a multiplicity of very fine nozzles into a spinning bath and crosslinks in this process into thin filaments. These thin, endlessly produced polyacrylonitrile filaments cross-linked in the spinning bath are then further transported, washed, dried, stretched and surface-treated before being oxidized in an oven at about 300° C. and subsequently subjected to a pyrolysis process and carbonized under exclusion of oxygen at temperatures of 800° C. up to 1800° C. or 3000° C.

The principle of these processes is not new, but today it is based on fossil materials origin, whereby the process is energetically driven by electric power.

During carbonization almost all the ingredients of the PAN fiber—for example Dralon—gas up to the carbon content, while the carbon atoms are crosslinking to form an atom grid of extreme tensile strength. Depending on the quality, the end product consists of 95% to 98% pure carbon in the form of carbon fibers.

The invention proposes to carry out the energy-consuming part of the oxidation and carbonization with the aid of bundled sunlight in a newly developed sunlight carbonization reactor (C reactor). In contrast to other materials, the fiber material is not heated like in case of steel, cement or aluminum which are being heated in large pots or basins in initially loose or liquid form, but heated at first in a relatively cold environment to form thin, endless fiber bundles which are driven into the heating process in a fixed and half-tensile-stable form and thus being easily introduced into the focal point of, for example, a parabolic mirror channel, and being moved forward in the same. Only a fibrous material consistency facilitates a simple, efficient and practicable movement in the focal point of a mirror or a lens for heating the material itself by means of sunlight, provided that the color of the fiber allows the initial heating, which is achieved by coloring the initially bright and light-reflecting PAN fiber with dark pigments.

The prerequisite for the further heating of the fibers, which oxidize in the further process at high temperature, whereby the color pigments burn and lose their effect, is ensured by the fact that the fiber per se is becoming darker as the oxidation process progresses and the degree of blackening is steadily increasing by the increasing carbon content. This enhances the degree of the ability of the material to convert light into heat and thus the efficiency of the light yield, which increases with increasing blackening to more than 90%.

The process of carbonization itself leads to an increase in the temperatures necessary for adequate carbonization. On the other hand, the resulting heat must be process related dissipated in order to protect the equipment and the necessary guide apparatures, and then finally serve as a kind of waste product for the electricity generation.

In fact, no other material can be imagined which delivers conditions to convert an utmost amount of light energy into heat, since carbon acts as an almost ideal black body in order to make the energy-intensive part of the manufacturing process as efficient as possible, and at the same time, almost uniquely based on direct regenerative energy sources, serve as a high-quality building material. No building material can be produced more efficiently in terms of energetic and environmental aspects, which at the same time provides weight advantages and tensile strength advantages over all known materials. An aluminum, steel or cement production by heating the material with direct sunlight is by no means as efficient and simple to be imagined.

Carbon fiber fibers are also interesting because they are easy to handle in their application and disposal, and above all they remain inert over Hundreds of millions of years in a stable aggregate condition, since reactivity is low due of the high production temperatures, in case the material is kept or stored under normal ambient conditions.

Therefore, the material can be stored safely away with little effort and without returning back into the environment in an uncontrolled way.

Since the production of such chemically stable carbon fibers is associated with a correspondingly high energy input, this energy must not only be produced in a CO2-neutral manner if the removal of carbon from the biosphere is to be achieved in a way that an overall negative balance of carbon concentration in the atmosphere is being realized with todays available technical and financial means, but the production itself needs to become necessarily more energy efficient.

For this reason, a method is proposed, which is new due to the fact that it proposes the generation of the necessary pyrolysis temperatures for the carbon fiber production by direct heat production by bundled sun light by help of an apparatus, in which the material to be produced itself is being heated up primarily by light and not by electricity, whereas at the same time the process-generated heat is being used for electricity production after being utilized for the carbonisation of the fiber. The generated electrical power can be used for some of the remaining process steps as well as for general power supply.

The bundling of the sun light, in order to achieve the necessary high pyrolysis temperatures, is achieved with the aid of parabolic mirror technology or lenses, such as, for example, Fresnel glasses or other geometry from mirrors and/or glass or quartz glass, at which the generation of the carbonization energy is not achieved by detour of electrical energy by means of solar thermal energy and conventional steam turbine generators or PV systems, but at which the light itself led onto the fiber to be produced is turned to become the pyrolysis energy directly.

The heating of the carbon fiber roving with Sunlight at simultaneous generation of electricity utilizes the sun power at an efficiency of up to 3 times higher than that of a scenario in which the electricity is first produced in solar thermal power plants and then being used in the carbon fiber furnaces to heat the fibers, because both processes involve high heat losses and, in addition, electricity transportation line losses.

The proposed arrangement uses at least 45% of the solar energy for carbonisation and the entire generated heat is available as before for the generation of electricity which works with an efficiency of about 30% in the desert and about 40% in cold high leveled areas.

In this way, the available amount of sunlight is used in total by approx. 75%, compared to today with approx. 25%, since in the comparison scenario of the carbon fiber production today the energy efficiency is 30% less 20% loss of conduction and heat loss in the carbonization furnace, which results in a total efficiency of 25% in the conventional process, in which sunlight is not directly used for the material production but via detour by electricity production of PV-systems or conventional CSP systems.

The net increase of efficiency of combined material- and electricity generation with bundled sunlight in desert areas is expected to comprise a factor of 3; in cold elevations, the efficiency can with a factor of 4 even be higher.

This kind of efficiency increase boosts the economy's reserves for such efforts which are needed for the return of 1430 gigatonnes of CO2 to pre-industrial levels, which is however an completely unrealistic scenario taking today's technology and economic structures into account, since due to the lack of efficiency, large time periods of well over 1000 years have to be claimed to reach this goal and thus a 1.5 or 2K target seems to be unattainable until 2100.

But if such a goal will become possible within the next 350 years, the motivation to quickly and consistently follow the way of replacing concrete, steel and aluminum with carbon fibers is much more attractive, especially since the combination of carbon fiber and hard rock already has an energy efficiency gain of factor 2 in contrast to steel and concrete.

In order to replace the quantities of construction materials required today, as shown later, between 0.2 and a maximum of 1.1 gigatonnes of carbon fibers from about 4 gigatons of CO2 have to be produced annually with the aid of example algae growth.

The production of 1 kg of carbon fibers requires an energy input of approx. 360 MJ and 100 kWh respectively. For the production of 1.1 gigatonnes of carbon, 110,000 TWh primary energy is being needed, which is close to the present world consumption of primary energy.

The calculations based on data from the Desertec project with an annual power generation capacity of 700 TWh and a cost of 400 billion EUR in 2050 have shown that with an efficiency increase of a factor of 3 this amount of energy can be generated with the use of 50 power stations of the order of Desertec.

In such a theoretical model calculation, approximately 1.1 gigatons of carbon fibers and 35,000 TWh of energy in the form of electrical power are being generated each year, which corresponds approximately to the global electrical power consumption expected for the year 2050.

The cost of such a power plant park based on the calculations for Desertec is comprising 20 trillion euros, calculated on 20 years depreciation the annual cost is at 1000 billion euros, which would have to be raised by the world community.

If a further calculation additional 1,000 billion are to be spent on maintenance and operation per year, the proposed scenario will cost 3.5% of the global economy, which is currently 60 trillion euros gross.

Such scenario creates material that replaces all CO2-intensive materials and saves 25,000 TWh of primary energy, which is currently spent annually on the production of reinforced concrete, steel and aluminum, as well as annually generated emissions of 4.2 gigatons of CO2, coincidentally approximately as much as would be linked to algae growth into the carbon fiber.

The annually generated electric power of 35,000 TWh covers the world current demand in 2050 and thus also the power requirement, with 2000 TWh to initially max. 3000 TWh per year, for the necessary amount of hard rock slabs to be cut, which must be added to the carbon fiber to replace the necessary annual quantities of 25 gigatonnes of reinforced concrete, as well as additional 0.8 gigatonnes of steel and 40 megatons of aluminum.

Construction of prototypes made of composite materials made of carbon fibers and granite such as walls (development at the HTW-Chur) and beams as steel and aluminum replacements, show that 0.2 to 0.4 gigatonnes of carbon fiber in combination with a maximum of 6 gigatonnes of granite is sufficient to replace all the reinforced concrete and a further 0.2 to 0.4 Gt of carbon fibers together with about 0.5 Gt of hard rock are sufficient to replace all the steel required. A further 0.3 Gt of carbon fibers are expected to replace other materials such as plastic and aluminum.

Together, a maximum of 1.1 Gt of carbon fibers is needed to replace all materials that cause CO2 emissions.

For the replacement of reinforced concrete, steel and aluminum, the solution proposed in InEP 106 20 92 is suitable, to use cut hard stone as a mineral component, since this can be produced with little energy expenditure by simple sawing of stone blocks. The connection between the carbon fibers and the mineral component is realized with resins, for example epoxide resins or mineral adhesives such as water glass. In the following, we speak of MCC, which stands for Mineral Carbon Composite. Instead of crushing CO2-containing limestone for cement production into fine dust and burning this material, with CO2 being released directly from the lime, with one third of the energy required for the production of concrete (equivalent to one-eighth of the energy required for the steel production)) hard rock blocks of, for example, granite can be cut into plates which are added to the carbon fiber to replace in combination all steel-concrete.

For an amount of 4 gigatonnes of cement consumption in 2013, approximately 20 gigatons of gravel, sand and water and approx. one gigaton of steel will be used in order to produce the annual needed quantities of 25 gigatons of steel-concrete. Also steel itself, as well as aluminum can be replaced by MCC in the same way if the necessary flexibility is brought into the MCC composite by prestressing, as described in the European patent application 08850169.7, since granite has almost the same gravity as aluminium. The MCC compound with the light carbon fiber has a weight that is even lighter than that of aluminum.

Model calculations show that MCC has already in the beginning of the replacement process an energy efficiency increase of a factor of 2 compared to reinforced concrete as well as steel and aluminum, even if the carbon fiber is initially produced by conventional methods.

As mentioned above, the annual primary energy used for the production of concrete, steel and aluminum is about 25,000 TWh, the MCC production to replace these amounts of material requires today with a minimized portion of carbon 13,500 TWh at a significant advantage of factor 2-3 in transportation weight.

However, the present invention is not only based on an overall energy-efficient operation but also on absorbing of as much CO2 as possible in order to regulate the climate system as quickly as possible. Firstly, a minimal carbon fiber content and the highest possible proportion of the rock are being used, whereby, as the number of C-reactors is increased, the proportion of carbon fibers should also be increased in relation to the hard rock content.

An initial quantity of approximately 6 gigatons of granite and later, when the carbon content increases, 4 gigatons of granite are technically capable of replacing 25 gigatonnes of steel concrete, 1 gigaton of steel and 100 megatons of aluminum per year, depending on how much carbon fiber can be produced at a given time. This is done with a total of 6-8 gigatons of MCC consisting of 4-6 gigatons of granite, 1.1 gigatonnes of carbon fiber and 0.9 gigaton of adhesive.

Calculating a cost factor of 2—with respect to the 3.5% cost of the global economy for the production of the carbon fiber based on algae oil—for the resin or waterglass needed for the production of MCC, the processing to final products and the further development of application technology, then for the replacement of aluminum, steel and reinforced concrete by carbon fibers, resin and stone a total of about 7% of the worlds economy turnover will be needed.

With a share of 15% of the world economy alone in the construction sector, an industrial restructuring of the economy in front of the backdrop of this cost calculation will be financially achievable within 20-30 years without financial disadvantages, as the other branches of steel and aluminum manufacturing industry contribute with a substantial share in addition and also their materials will be replaced by these 7% of the world economy.

The costs of Desertec also say that these 7% of the world economy would be able to meet the costs of a future rising demand for electricity, as the scenario described above covers the electricity needed in 2050, as our model calculation however is based on an economic performance of 2013. By 2050, as expected, economic growth will once again grow significantly as a result of the increase in the world's population, which will also help finance industrial restructuring.

With a combined capacity of 50 desertec power plants and an efficiency increase of a factor of 3 by the combined production 25 carbon material and electricity, a Maximum of 1.1 gigatonnes of carbon in the form of carbon fiber can be bound at realizable costs from the ocean and the atmosphere, provided that the required amount of algae oil is available. The quantity of 388 gigatonnes of carbon, which corresponds to 1430 gigatonnes of CO2, which has been introduced by human beings, can be recycled in the foreseeable time of 400 years and permanently bound within the carbon fiber.

The described scenarios can not be implemented immediately. The time required for the implementation to keep the mean global warming under the critical mark of 2° C. in 2100 can not yet be said in this patent application, and is subject to further developments and further calculations based on these developments.

The primary goal at first is to normalize CO2 concentrations within the coming 350 to 400 years in the direction of a pre-industrial level, even if a further increase in CO2 emissions can be expected in the short term until the processes described here can be introduced.

Even if a real scenario, also due to the necessary start-up times, will be displaced at the end by 30% from these targets, so that it can be reached that 70% of the today installed quantities of steel, reinforced concrete and aluminum can be replaced, it seems to be possible today to close the gap by other CO2-binding measures, such as the afforestation of the rainforests and recultivation of soils by the introduction of bound carbon in the form of biomass, instead of felling further primeval forests for the extraction of bauxite for aluminum production.

An ambitious 350-year target should be maintained in any case in order to stay below the limit of the 2° target until 2100, which has been set by climate research as being necessary and limit it to a maximum of 1.5° C. The globally required ocean area for the production of the algae material required for the carbon fiber production of the quantity of 1.1 gigatons—this corresponds to the binding of 4 gigatons of CO2 per year—is possible on a surface of a maximum of 2 million km2 distributed around the world, which is corresponding to the area of Algeria. For the production of the required resin approximately the same surface is still added if the resins are made from algae oil as well, which additionally binds CO2 in the short and medium term.

The production power of the resin from algae oil, as well as for the collection, the transport and the re-refining of the oil is already included in the required quantity of algae in this calculation. In the technique proposed here, and this becomes the core of the invention, primarily the fiber itself Is heated by the sunlight at the focal point of the mirror, oxidized under oxygen supply, and carbonized in the final phase of the process under the exclusion of oxygen. The strength of the fiber or fiber string to be heated is initially irrelevant, since this process can be scaled from the smallest dimensions to strong fiber bundles. Many small or very small miniature production units are also conceivable, which work in large numbers in parallel.

For this purpose, for example, a longitudinal mirror arrangement linearly arranged along an axis (z-axis) and which has a parabolic shape in the x-y plane is being used. The focal point (F) lies on a line with a constant xy-coordinate. We speak henceworward of the linear focal point or in short focal point, which is originally not a point, but in fact a multiplicity of linearly arranged focal points, which is a focal line.

The mirror is irradiated by the sunlight (S) and tracked in the x-y plane in such a way that the focal point of the parabola is always hit by the sun's rays. The fiber to be produced is positioned at the focal point and moved continuously along the focal line, whereby the fiber is being constantly heated up.

For this purpose, a starting fiber suitable for the carbon fiber production, from for example polyacrylonitrile, or PAN fiber, is introduced linearly from one end into the focal line of the parabolic mirror, and is continuously moved and heated at an adapted velocity along the focal line within a gas-continuumas long as the initially bright PAN-fiber is being oxidized and during this oxidization process is getting ever darker, until it reaches at the end of this oxydization phase at a temperature of about 300° C. a very dark colour.

The fiber is then moved further along the focal line within the pyrolysis phase under the exclusion of oxygen, for example in a gas consisting mainly of nitrogen, as long as it is firstly heated up to 800° C. and then depending on quality futher up to 1800° C. or 3000° C. respectively, until the carbonization process at the outlet of the linear-parabolic mirror is completed.

The oxidized PAN fiber is becoming increasingly black as the carbon content increases in the pyrolysis phase and, as a result of this self-reinforcing effect, it receives ever higher temperatures, until the fiber starts to glow.

The resulting temperatures must be controlled from the outside by cooling in order not to destroy the required equipment by overheating. The gases surrounding the fiber string must be translucent in order not to hinder the heating of the fiber string.

In order to supply these necessary gas media, also translucent solid vessels in rectangular or cylindrical tube form are being used.

These can consist of transparent or translucent glass or another temperature-resistant and transparent or translucent solid body, such as quartz glass or high-temperature-resistant plastic.

Because of the gas temperatures constantly rising along the focal line, the glass vessel walls must be cooled externally in the pyrolysis phase so that they do not melt.

This cooling takes place by means of gas or liquids which flow between the inner and additional vessel wall, which also is a transparent, rectangular or cylindrical tube wall.

The cooling gas or the cooling liquid is also translucent or transparent, in order to let the light through to the carbon fiber string without damping. At this point air, water or temperature-stable oil, such as silicone oils, can be utilized. The heat is passed through heat exchangers to a water circuit that drives steam turbine generators for the production of electricity.

In order to prevent the carbon fiber string from sagging through the gravity, it must be guided. In the oxidation phase, there are no material problems at this point. For the guide, stainless steels can be used, corrosive material should be avoided.

In the pyrolysis phase, the materials used for the centering of the fibers at the focal point must be temperature-resistant in such a way that they do not melt at the respective temperatures. For this purpose, high-temperature-resistant metals such as, for example, molybdenum or tungsten are appropriate, whose melting point is higher than the maximum temperature attainable during pyrolysis, or other high-temperature-resistant materials. By means of concentrically arranged nozzles in the walls of the glass tubes, the combustion chambers are supplied gas within guiding tube, in the oxidation phase being fed with oxygen-containing gas, and in the pyrolysis phase fed with nitrogen, for example, to avoid burning the fiber by oxidation with oxygen and thus avoid terminating the carbonization process.

The Tungsten wire is not getting so hot, that it reaches its melting point of approx. 3.400° Celsius, since the fiber is completely carbonized at maximum of 3.100° Celsius.

As soon as the desired pyrolysis temperature is reached, this temperature must be maintained between 1500° C. and 3000 C, depending on the temperature setting.

Depending on the temperature setting, the holding phase lasts, longer at low temperatures as with short (correction: short is meaning high) temperatures.

Since the fiber itself starts to radiate at appropriate temperatures, the further heating by bundled sunlight can and should be intercepted or else completely broken off.

In order to prevent the fiber from cooling down again due to the self-radiation, it is guided in a guide tube, which is mirror-coated from the inside so that the heat energy is not radiated off again and lost, which would mean that the necessary holding phase is interrupted or broken off respectively.

After the holding phase, a cooling phase begins because the temperature of the finished carbon fiber needs to be brought back to normal ambient temperature.

Since the guide tubes have to be correspondingly long, they are composed of similar parts. With the method described here for producing carbon fibers, a great amount of heat is being produced in the carbonization phase, which needs to be discharged at a specific point in time or at certain points in time so that the guide tube does not become too hot and does not melt on one hand and the fiber is cooled down again on the end of the pyrolysis process on the other hand. This cooling can also take place by radiation or by a mixed cooling by radiation and convection of internal and/or external coolants.

The heat transport is ensured by a further enveloping pipe and the heat quantity is used via heat exchangers to produce electrical energy and, if necessary, the residual heat is also used for heating, since the process is preferably implemented in cold elevated plains, as the efficiency of electricity generation increases there and the availability of sunlight appears to be optimal, as in the high plains of Peru, Bolivia or Tibet.

In addition, the heated pyrolysis gas being introduced into the carbonization tubes through the above-described nozzles needs to be sucked off to a certain extent at the end of the tube where the carbon fiber terminates the pyrolysis process in order to remove the gases liberated during the pyrolysis, such as hydrogen and oxygen.

This heated gas is also cooled by means of heat exchangers, cleaned and, at the beginning of the respective process, returned to the pipe system in the cooled state.

The heat exchangers also heat up the water circuit, which drives the steam turbines.

The cooled gas is then returned to the carbonization tube through the nozzles described above, with spent oxygen being added to the gas during the oxidation phase.

The described arrangement achieves three positive effects at once:

Firstly, the high energy for producing carbon fibers is provided by purely regenerative energy sources—in this case the sun. Since the energy is obtained by heating a optimal black body and not via detour of electricity use or by heating other, less black bodies, the energy is optimally utilized with respect to the technical and thus financial expenditure for exploited sunlight and thus at a maximum energy- and cost-efficient. consumption.

Secondly, with this sunlight, not only the highest quality building material is being produced, but the heat energy being generated during this process is also used to generate electricity, as is the case with solar thermal power plants, for example using conventional steam turbines, in case the heat developed during the carbonization process is selectively removed and passed through heat exchangers and thus is converted into electricity. Electricity is thus produced as a “waste product” in addition to the output of high-quality building- and construction-materials.

The heat that is still remaining and can no longer be used for generating electricity can be used for heating buildings, since such power plants can preferably be installed better in cold regions such as elevated plains, not only because the higher temperature gradients make electricity generation more efficient, than in warm desert areas, which also offer sunshine around the clock, but also due to possible desert storms with damages of the sensitive glass and mirror surface by fine grinding sand have to be taken into account. Ideally, the further processing to carbon fiber end products could well be located near the C-reactors.

Thirdly, in this type of combined material and power generation, a material is created which has the potential to permanently remove so much carbon from the atmosphere that a CO2 concentration can be reached again at the preindustrial level of 280 ppm in manageable time periods.

In this way, 380 gigatons of carbon can be withdrawn from the atmosphere and/or the oceans over a period of 380 years at a start-up time of the process of 30 years, if a quantity of 1.1 gigatonne of carbon fibers is produced annually for a duration of 350 years being produced on the basis of vegetable oils. In this case, the absorption potential of the resin, which can also be produced on the basis of algae oil, has not yet been considered.

In view of the fact that around 4 gigatonnes of cement and 0.8 gigatonnes of steel were produced in 2013 to produce approximately 25 gigatonnes of concrete, this quantity appears to be replaceable by the much lighter and more resilient carbon fibers, as described in EP 10620 92, in case it is being supplemented by natural stone, which can be won and recovered with considerably less energy—than the energy-intensive production of cement, which is burdened with a lot of additional CO2 emissions. However, it would be desirable for the carbon fiber content to increase rapidly to maintain the 350 years for the return of CO2.

The world economy has every freedom under the described scenario to speed up economy in order to accelerate these processes.

This will happen through the economic growth anyway, which effect has not been taken into account yet in the calculation of the 350 years and is left to future generations to investigate and exploit these possibilities.

The present invention has the purpose to offer the principle of a new carbon age argumentatively and introduce them, in case the arguments are plausible.

On the contrary, to the satisfaction of the existing industries it can be argued that if there is a safe, industrially driven mechanism for the permanent removal of carbon from the atmosphere—as suggested in this application —Humans can afford the production of steel and reinforced concrete for certain applications within certain limits, for example within a range of 30%, provided the overall balance of CO2 emissions remains significantly negative or at least CO2-neutral over a certain period of time.

Strictly speaking, under the described scenario not even emission certificates are needed, provided that a carbon-based substitute material is consistently introduced. Emission allowances, however, are all likely to be necessary in order to initiate these processes.

In case the starting materials for the production of the carbon fibers (PAN fibers) are obtained from vegetable raw materials such as vegetable oil or, better still, algae oil, carbon is bound within the carbon fiber, which has previously been carbon dioxide in the atmosphere or in the ocean, whereas under increasingly important aspects valuable oxygen Is being returned to the nature by the photosynthesis of plant or algae growth, which itself decreases with increasing CO2 content, which is at present insufficiently addressed, but which can make lung ventilation in some hundred years impossible, in case the CO2 emissions at rates being observed today continue to rise and reach a level of 1000 ppm. The algae has to be regarded as a raw material source for 2 reasons. The first reason is that the production of vegetable oil does not compete with food production for the currently growing world population. Second, the algae deprive the seas of the CO2 which is responsible for the increasing acidification of the seas.

The question of recycling the carbon material is only a secondary issue in this scenario because the carbon fiber products can be easily and safely disposed of after their use, since the carbon is in an absolutely stable state for over 100 millions of years and the carbon—applied only to the surface of the stone—can easily be separated from the natural stone. This is because the resin which connects the two components mechanically is the weakest component and the substantially stiffer carbon fiber layer—in contrary to the less stiff glass fiber—can be completely detached without ripping off from the stone layer without too much effort.

It is simply discarded after use, transported to underground storage with little energy, such as into the abandoned coal mines in Germany or other mines.

The carbon fiber produced under the method of this invention can make a significant contribution to a long-term and safe geo-engineering of greenhouse gases, whereby the economy—by using carbon fibers as a replacement of CO2-intensive materials such as steel and aluminum and concrete—is no longer acting as polluter, but will turn itself into an engine for sustainable carbon-sequestration, whereas the carbon is stored after use until one day it can be reused by future generations.

Carbon fibers that are no longer needed and disposed of can thus be reactivated by future generations without great effort, if necessary as a valuable carbon reserve, for example when the sun's activity diminishes over the centuries or millennia, and the carbon for the heating of the atmosphere by combustion into CO2 would have to be re-activated, causing the carbon fiber to be closed in a long-term recycling process, the handling of which is simple and safe.

Thus, at the highest and most viable level of future planning a simple, but sustainable “Cradle to Grave” and later on “cradle to cradle” principle is being implemented, which is necessary for the most vital functions of atmosphere and biosphere in the long term: a controllable carbon and oxygen budget for the growth of plants and preservation of lung and gill breathing at the same time.

Compression of carbon into subterranean layers, the so-called carbon (dioxide) storage (CS) appears to be completely unsuitable and unnecessary to address the CO2 problem in the context of the scenario described above.

Whereas the segregation or sequestration of CO2 with the currently still necessary firing of fossil fuels however and in order to energetically realize in the medium-term the scenario described above, as well as the associated conversion of the industry, appears as being extremely helpful, since the sequestered CO2 can likewise be fed into artificial algae growth in algae-tanks.

By compression of CO2 into deeper rock layers or empty or still exploitable oil and gas sources, much more space is needed than by the storage of pure carbon, as it is in the case of carbon fiber with more than 95% carbon content, since with every carbon atom two valuable oxygen atoms are lost.

The transfer of pure carbon fibers into abandoned coal mines is also a much more energy-efficient process than the energy-intensive compression of CO2 into the earth, where not only the valuable carbon irretrievably lands but the oxygen, which is forgotten in the discussion so far. The oxygen bound in the CO2 vanishes uncontrollably, because today nobody can say, in which time the compressed CO2 finds its way back into the atmosphere.

The present invention described herein, however, provides for a controlled and controllable handling of carbon and oxygen. All previous processes for the production of building materials currently produce uncontrollable amounts of CO2 on a long term basis, under consumption of costly produced electricity and binding of oxygen.

With the aid of the present invention, these ratios are totally reversed. The presented process produces completely regeneratively produced building material and regenerative electricity and creates control over the CO2 concentration by its reduction, whereas life-indispensable oxygen is being released.

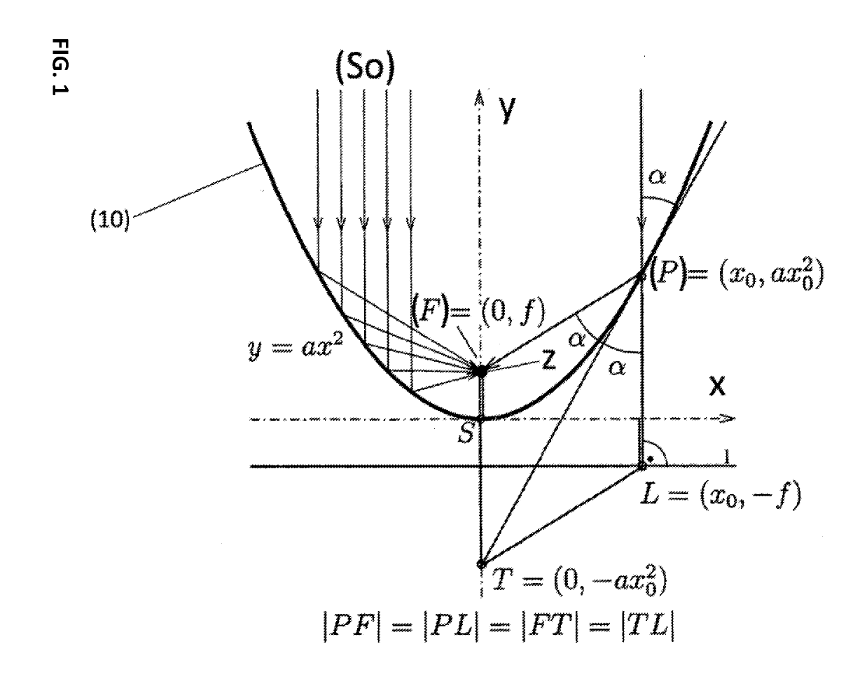

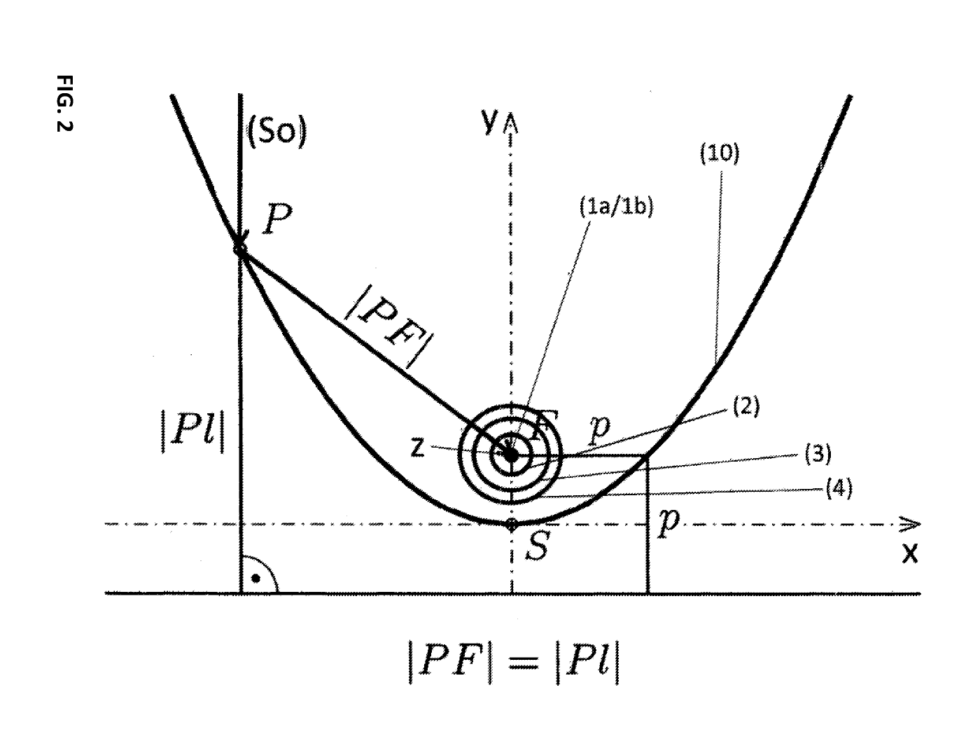

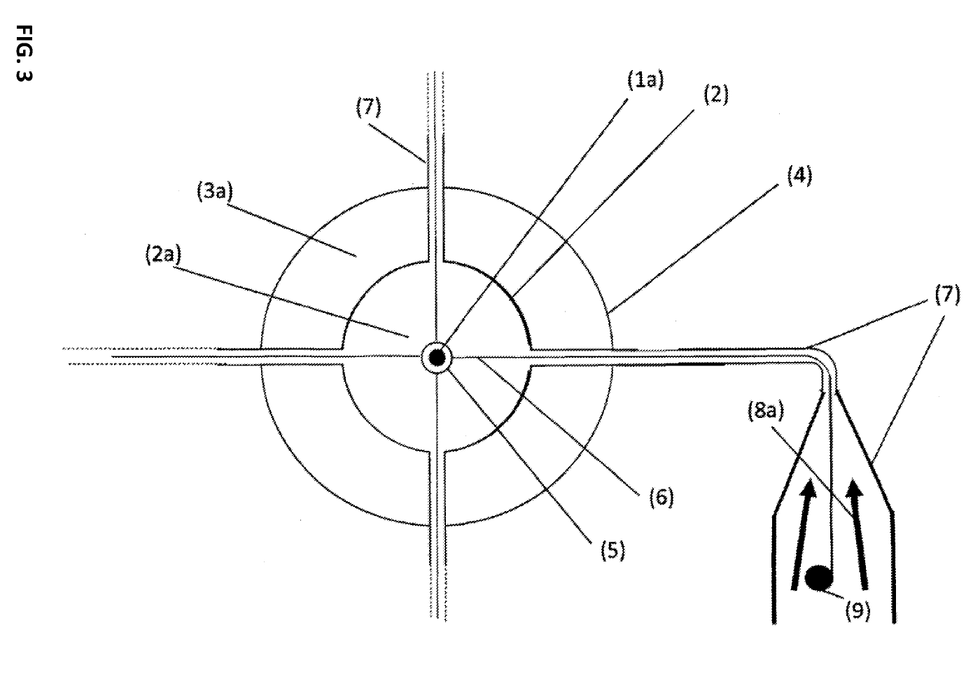

One of the many possible embodiments of the invention describes in FIGS. 1 and 2 an arrangement with conventional linear-parabolic mirrors (10) or alternatively in a row arranged Fresnel-lenses or linearly arranged focusing balls, whereas within their focus (F), however, in contrast to a conventional power station based on bundled sunlight (So), there does not exist primarily a heating pipe with a liquid which is to be heated, but rather the starting materials to be heated in preparation of the production of carbon fibers, for example in the form of polyacrylonitrile or in short PAN fibers (1a) in FIG. 3, for example Dralon fiber.

These fibers are driven individually or in the bundle at a specific speed through the longitudinally formed focal point (F) or the aligned foci, ie along a focal line (Z), and thereby slowly but steadily heated by the bundled sunlight (So).

The process takes as long as the carbon fiber needs to get the starting fiber of polyacrylonitrile to take up the necessary thermal energy for the oxidation process to up to approx. 300° C. and for the subsequent carbonization process underexclusion of oxygen to up to 1500-1600° C. or even up to 3000° C.

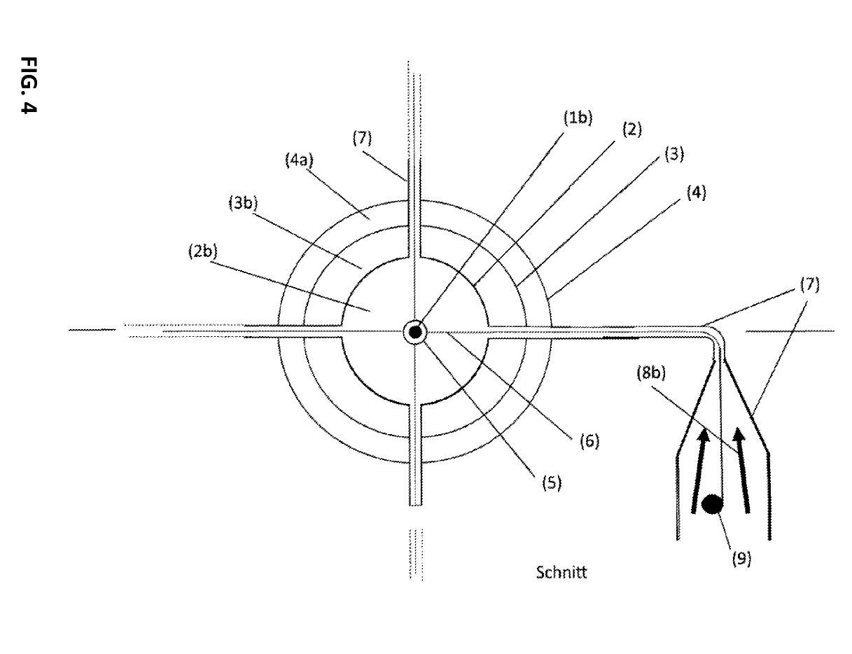

For this purpose, the PAN fiber is being guided within a transparent tube of, for example, glass, quartz glass or glass ceramic (2), which in the oxidation phase and the carbonization phase is filled with different, likewise transparent gases (2a) in the oxidation phase (FIGS. 3) and (2b) in the pyrolysis phase (FIG. 4). In the oxidation phase in FIG. 3 the fiber bundle is located in an oxygen-containing gas mixture (2a) and is heated up to about 300° C. during this phase.

The glass tube (2) surrounding the fiber bundle is thereby not subjected to critical temperatures which would necessitate cooling of the tubes because the melting temperature of glass is not being reached.

For this reason it is possible during this phase to use a the tube (2) surrounding vacuum (3a) with the aid of a tube (4) surrounding the tube (2) in order to avoid unnecessary heat losses during this phase.

FIG. 3 shows how first the PAN fiber string is guided in the oxidation phase.

The guide rings (5) are being held at regular intervals in the middle of the oxidation tube by wires (6) from temperature-resistant material such as stainless steel, tungsten or molybdenum. The continuum around the PAN fiber string consists of oxygen-containing gas (2a). The rings preferably consist of temperature-stable, non-corrosive metal, tungsten or molybdenum.

The wires are passed through tubes (7), which are crossing the cylindric tubes (2) and (4), whereas the length of the wires (6) is adjusted electronically controlled by winding rollers (9) in order to hold the fiber string in the focal line, whereas at the same time gas (2a) can be blown through the tubes (7) in order to supply oxygen consumed by oxidation (8a).

In the carbonization phase (FIG. 4), the carbon fiber (1b) to be carbonized or the carbon fiber being formed respectively is located in a space filled with nitrogen (2b) in order to prevent from further oxidation and the burning of the material by further heating up to 800° C. at first and later onto up to 1800° or even 3000° C. during the pyrolysis process, in which the new chaining of the carbon atoms (carbonization) happens, which is responsible for the later on high tensile strength and stiffness of the carbon fiber, takes place.

Since the transparent glass tube (2)—carbonization or pyrolysis tube—would melt at the high temperatures required for the pyrolysis, since the gas (2b) also reaches temperatures exceeding the melting temperature of the tube (2) to form a completed continuum of nitrogen (2b) or another transparent oxygen-free gas around the fiber string, and at the same time allow the bundled light to pass through to the fiber string for heating it through the wall of the glass without great optical resistance, the tube needs to be cooled externally by a transparent gas, for example air, or a suitable transparent liquid, for example temperature-resistant silicone oil (3b).

For this purpose, the inner glass flask is surrounded by a second enveloping glass flask (3) so that this cooling gas or the cooling liquid (3b) deliberately removes such an amount of thermal energy that the inner glass tube (2) always remains at a temperature below its melting point.

As long as this heated cooling gas or heated cooling liquid (3b) in turn used a cooling water circuit with a heat exchanger for its own cooling, electricity can be generated from the heat dissipated thereby by means of conventional power station technology with steam-turbine-driven generators.

The heat generated during the carbonization process is thus simultaneously used for the generation of electricity.

In order to optimize the heat supply of the medium (3b) towards the electrical energy-producing systems and thus to keep the total heat losses as low as possible, FIG. 4) shows how the second glass wall (3) is being surrounded by a third glass wall and the space between these two outer glass walls is provided with a vacuum (4a).

In this way, the heat generated during the carbonization process is optimally used for the generation of electricity, and the up to now substantially more inefficient carbonization of the carbon fiber by help of electrical power heating, is being replaced by a self-amplifying darkening process and corresponding heating by sunlight.

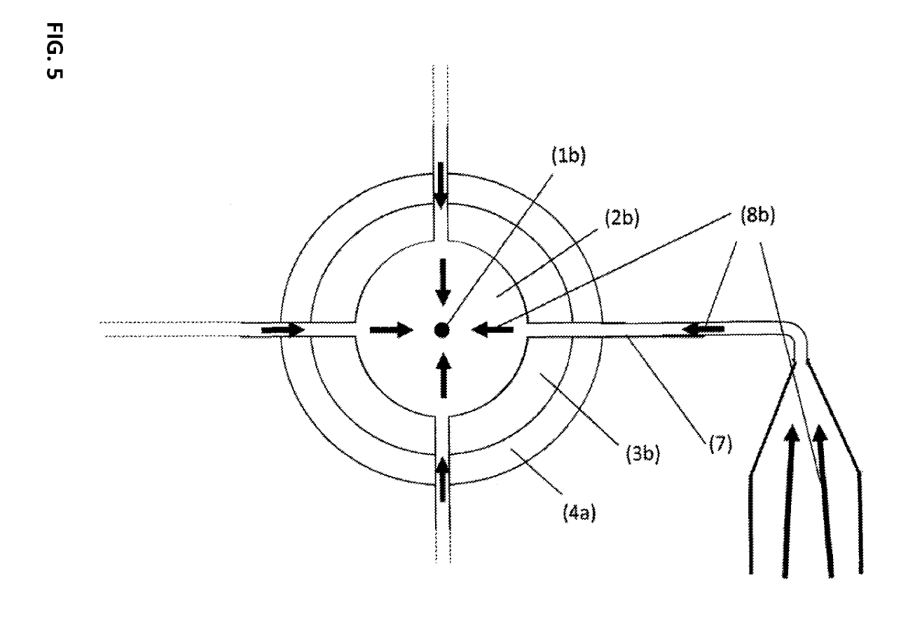

Within the regions of the higher temperatures, succeeding the oxidation phase to up to about 800° C. and the pyrolysis phase up to 1800° C. and above, it is shown in FIGS. 4 and 5, how the fiber string is being guided into the pyrolysis phase.

The guide rings (5) are held at regular intervals in the center of the pyrolysis tube (2) by wires (6) made as well of extremely temperature-stable material such as tungsten or molybdenum.

The continuum around the PAN fiber string consists in the pyrolysis phase of a gas which does not contain oxygen, for example nitrogen (2b). The rings preferably also consist of temperature-stable tungsten or molybdenum, which resist temperatures which are above the pyrolysis temperature.

The wires are passed through tubes (7) which pass through the walls of the cylindrical tubes (2), (3) and (4) and adjust the length of the wires (6) electronically via winding rollers (9).

At the same time, nitrogen (8b) is blown through the tubes (7), which is being discharged at the outlet of the carbon fiber string from the carbonization tubes and purified in order to be reused.

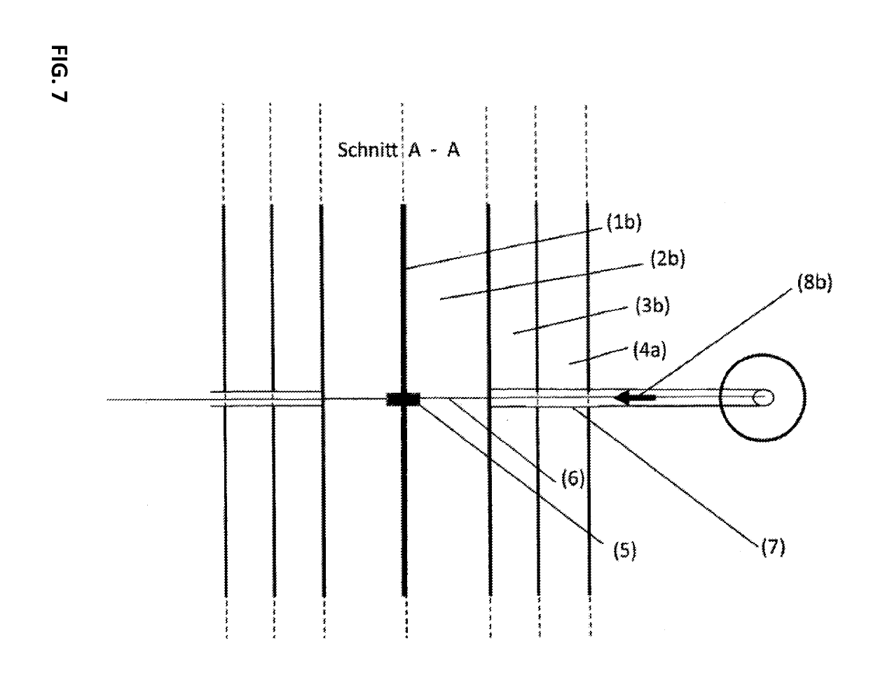

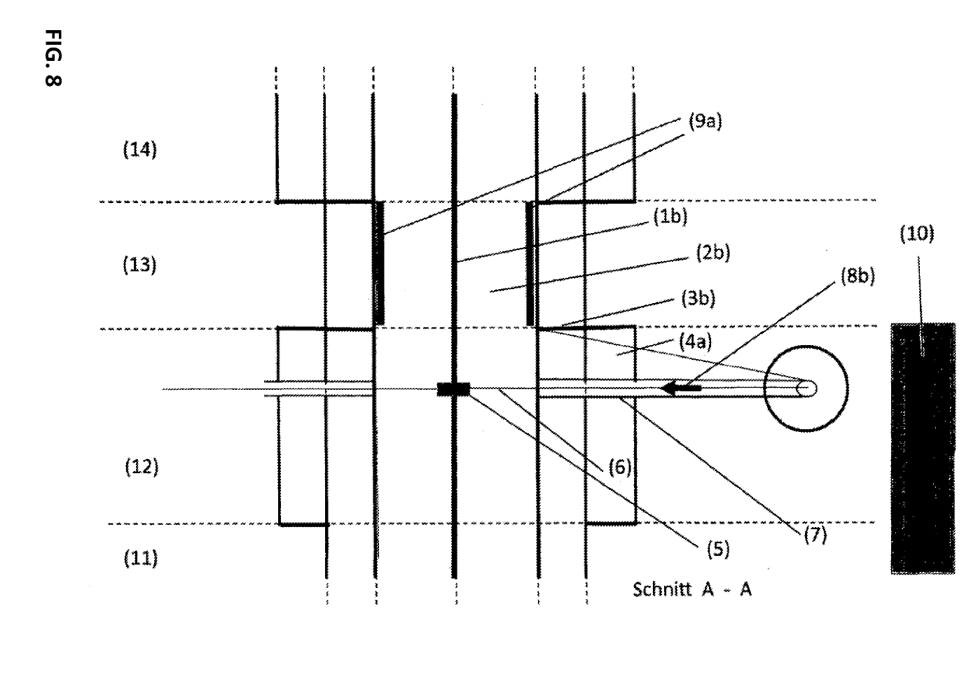

FIG. 7 shows a cross-section through the carbonization tube in the region of the pyrolysis-heating-zone in FIG. 8.

FIG. 8 shows a section through the entire carbonization track, beginning with the oxidation phase (11), in which the required heat energy is supplied either by means of parabolic mirrors or via electric heating for the oxidation of the PAN fiber, via the pyrolysis heating phase (12) by means of parabolic mirror heating and holding phase (13) with internally mirrored tube, up to the subsequent cooling phase (14), as well as the parabolic mirrors in zones (11) and (12).

The pyrolysis zone (12) is adjoined by a holding zone (13), whereby the pyrolysis time is adjusted by its—in relation to each other—adjustable length and function of the pyrolysis temperature and feed rate of the fiber.

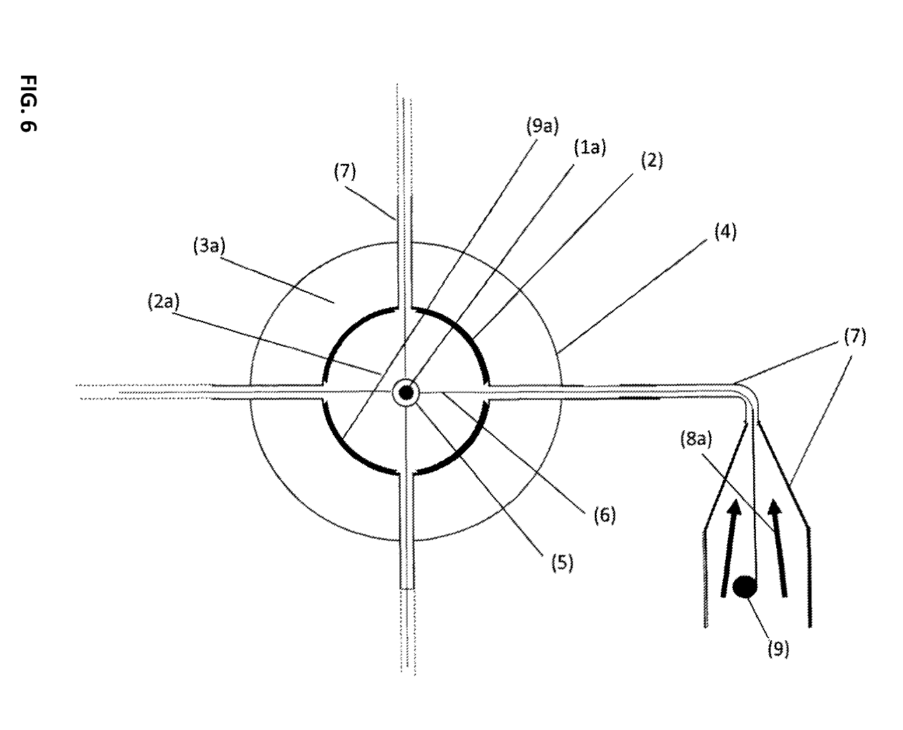

Since the fiber itself emits radiation in the visible light range at pyrolysis temperature, this reflection is prevented by a full reflection mirroring (9a) on the inner wall of the pyrolysis tube in the holding phase following the heating phase (FIG. 6), so that the radiation energy is preferably suffering from as less losses as possible, so that the pyrolysis temperature can be maintained for a further distance without reheating through the parabolic mirrors.

The need for the parabolic mirrors is not required in this section, only the inner mirroring (9a) of the inner tube or alternatively the outer tube is required.

A vacuum (3a) ensures also at this point the necessary insulation against heat losses in the holding zone.

Following the temperature holding phase (13), the cooling phase (14) follows, in which a single-walled or double-walled tube can be used.

The cooling takes place by convection of a cooling gas in the inner tube, via the additional convection of a liquid or a gas within a second tube layer, which may not necessarily be transparent, but may be light-absorbing, or by radiation through a transparent tube system onto a black body, which is used as a heating system within a heat exchanger system, ie is cooled by water, whereas the heated water is also being used for the generation of electricity.

The described arrangement initially means a factor of 3 in the increase in efficiency compared to a process, in which electricity is being produced at first by conventional CSP parabolic mirror technology to serve for the carbonization of the fiber, since the efficiency of the power generation can be only at a maximum of 35% due to the associated heat loss.

Since, in the carbonization reactor described here, the light is initially converted to at least 45% into carbonization energy in the form of heat on the carbon fiber itself, the utilization of the light is therefore nearly twice as high as in the conventional method of primary generation of electricity and since additionally about 30% of the total heat is converted into electricity energy, a total utilization of the light energy of 75% can be assumed.

Cement burning or steel cooking can hardly be done with this principle, which is why the carbon fiber production with sunlight light in front of the background of the significantly higher energy efficiency, the low weight and the possibility of binding of carbon of anthropogenic origin is more sustainable than the production of conventional materials.

Even the production of carbon fibers of fossil origin would benefit this process superiority to conventional processes and methods, even if at first the carbon is not removed from the atmosphere, nevertheless, this process would be at the very beginning of the introduction of this process when the PAN fiber was initially not be produced in the required amounts from algae oils, but from fossil oil, a significant mitigation of greenhouse gas emissions due to the higher energy efficiency is associated with this new process, especially since already today the necessary total energy for building with carbon fiber and natural stone is approx 50% less than in building with steel and concrete, thus avoiding CO2 emissions already in the introduction phase of the new material (see, for example, EP 106 20 92). The increase in the total efficiency can comprise a factor of 4.

1. A system for production of carbon fibers from synthetic plastic fibers by means of bundled sunlight, comprising:
synthetic plastic fibers which are being moved forward continuously within a transparent tube as parallel bundles along a focal line of light-focusing arrangements and becoming by dark in color, which is required for oxidation by continuous heating;
a self-optimizing energy sink of light, getting so dark black, that fibers are being heated without indirect heating but only by direct irradiated sunlight, wherein the fibers reach the necessary high temperatures of at least 1800° C. needed for a pyrolysis process to occur and;
wherein a grade of conversion of light into heat is steadily growing; and whereas the pyrolysis process is being controlled by cooling from outside through cooling gases or liquids in such a way, that transparent vessels or guiding-tubes guiding the pyrolysis process are not melting due to high carbonization temperatures within an area of a heating zone of the high-temperature pyrolysis process; and
wherein a tube system, surrounds fiber roving, wherein the fiber roving -is being protected against exceedance of critical temperatures and;
wherein the tube system consists of:
an inner tube, comprising a carbonization tube,
a section of the carbonization tube, wherein oxidization takes place called an oxidization zone, and,
a section of the carbonization tube in which the pyrolysis process happens called a pyrolysis zone, and
a cooling zone of the carbonization tube.

2. The system of claim 1, wherein bundling of sun rays is being generated by means of parabolic mirrors or focusing glasses; wherein the glasses or mirror comprise at least one of fresnel lenses with or focusing geometries from at least one of mirrors, glass, quartz-glass, diamond or a combination thereof.

3. The system of claim 2, wherein the parabolic mirrors or focusing glasses are being arranged along a straight or curved focal line.

4. The system of claim 1 wherein, the fibers are carbonized and guided as a single fiber or as a fiber bundle in the carbonizing tube and are moved along and at the center of the focal line.

5. The system of claim 1 where in the carbonization tube is being filled with -gas to be transported.

6. The system of claim 1, wherein the gas within the pyrolysis tube contains oxygen or excludes oxygen depending on a phase of oxidation or pyrolysis.

7. The system of claim 1, wherein the pyrolysis tube in the heating zone is passed through a second transparent tube for cooling, and wherein a cooling transparent gas or a cooling transparent liquid is guided and moved between the tubes, which, via a heat exchanger which supplies a conventional power plant with water steam turbines with necessary heat energy.

8. The system of claim 1, wherein the pyrolysis tube is surrounded in the oxidation phase and the pyrolysis heating zone by a heat-insulating vacuum with help of an additional transparent tube-walls.

9. The system of claim 1, wherein the pyrolysis tube is cooled externally in such a way that the fiber is reaching the end of the process string and the temperature necessary for a sufficient or complete carbonization without the walls of the pyrolysis tube reaching their melting temperature.

10. The system of claim 1 wherein a region of the pyrolysis tube comprises a second tube surrounded by a third tube or vessel, and wherein a heat-insulating transparent gas or a vacuum is arranged between the second tube and third tube.

11. The system of claim 1, wherein the carbon fiber string in the center of the pyrolysis tube along the focal line is held by a material having a higher melting point than the maximum pyrolysis temperature required for carbonization, such as high-temperature-resistant steel, tungsten or molybdenum.

12. The system of claim 1 wherein-inlet pipes are arranged at regular intervals on the carbonization tube, through which holding structures are guided and adjusted and, which are tempered; and wherein purified gas is being blown on demand, and which must be replenished;.

13. The system of claim 1, wherein PAN fiber in the oxidation phase is sufficiently pigmented for heating by means of solar light.

14. The system of claim 1 wherein a holding phase follows the pyrolysis phase after heating up to maximum temperature, in which the parabolic mirror zone terminates and no further light energy supply takes place, and wherein the carbon fiber, which has been brought up to glowing temperatures during the pyrolysis heating phase, will be kept glowing by means of inner mirroring of the carbonization tube such that radiation by the glowing carbon string reflects back onto the string and the temperature will be kept at a largely constant level.

15. The system of claims 1 where-in during the holding phase, the carbonization tube is surrounded by a vacuum and solely cooled by nitrogen gas flowing within the tube.

16. The system of claims 1 wherein cooling phases follows the holding phase, wherein the tubes transparent and the radiation is reflected on black bodies and converted into heat or wherein the tubes are not transparent wherein the radiation is heating up a non-transparent tube wall through which the heat is being moved away by convection.

17. The system of claim 1 wherein any form of radiation and heat energy is supplied to a water circuit for the generation of electricity in at least one of the oxidation, pyrolysis and cooling phases via heat exchangers.

18. The system of claims 1 wherein transparent tubes are partially made of —or all made of at least one of—quartz glass, glass or plastic.

19. The system of claim 1, wherein the interior space of the carbonization tube is leakproof due to the introduction of PAN fiber.
